(19) United States
(12) Patent Application Publication
(10) Pub. No.: US 2024/0232451 A9
(43) Pub. Date: Jul. 11, 2024

(54) A TOPOLOGY OPTIMIZATION SYSTEM

(71) Applicant: TUSAS- TURK HAVACILIK VE UZAY SANAYII ANONIM SIRKETI, Ankara (TR)

(72) Inventors: Istemihan GOKDAG, Ankara (TR); Hakan YAVAS, Ankara (TR); Erdem ACAR, Ankara (TR)

(21) Appl. No.: 18/278,236

(22) PCT Filed: Feb. 25, 2022
(86) PCT No.: PCT/TR2022/050173

§ 371 Date: Aug. 22, 2023

(30) Foreign Application Priority Data
Feb. 26, 2021 (TR) 2021/003400

(51) Int. Cl. G06F 30/17; G06F 30/23; G06F 113/10

(52) U.S. Cl. CPC G06F 30/17; G06F 30/23; G06F 2113/10

(57) ABSTRACT

The present invention relates to at least one part (P) produced by an additive manufacturing method; a table (2) which allows production of a part (P) thereon; at least one digital model (3) created for the purpose of three-dimensional part (P) analysis and/or design in a virtual environment; a plurality of unit design cells (4) that allow the digital model (3) to be created; at least one processor unit (5) that allows creation of a digital model (3) from the unit design cells (4); a plurality of specimens (S), each produced by the manufacturer in a different direction and/or position on the table (2); and at least one database (6) which is created with mechanical property data obtained from the specimens (S).

The present invention relates to optimization of parts produced on additive manufacturing machines.

Additive manufacturing, or more commonly known as three-dimensional printing, is a production method which enables production of three-dimensional parts and/or prototypes by laying metal, ceramic or polymer layers on top of suitable powders or fine wires and subjecting them to heat treatment by a printer tip.

In the context of fast-growing aerospace technologies, the production of metal materials by additive manufacturing gains importance and process improvement studies continue rapidly. It is used for melting or sintering of metal powders laid by using heat sources, such as electron beams or laser sources, especially for the production of metallic aerospace parts. During the process, metal particles mostly in micrometer sizes are supplied, which meet the defined requirements, and these particles are then laid on a vertically moveable plate with a high melting point, which can be heated. Thanks to this method, it is possible to produce parts with complex geometries such as multi-axis parts or parts with internal channels, which cannot be produced in conventional production methods like machining. Thanks to the freedom by additive manufacturing, it is possible to produce lighter and durable parts with complex geometry with a high specific strength by means of the topology optimization, which would otherwise be difficult to produce in machining. While making topology optimization, it is expected that the part to be produced will have a minimum compliance. During the design, artificial densities between 0 and 1 are assigned to the design cells on the part, such that the excessive design cells are discarded in consecutive iterations. As a result of the optimization, a new part design with high specific strength is obtained.

Patent Application no. US20180276889, which is included in the state of the art, discloses topology optimization based on orthotropic material properties and selected additive manufacturing production method, finite element analysis based the anisotropic properties of the material, finding factor of safety between iterations, and obtaining a minimum factor of safety.

Thanks to a topology optimization system according to the present invention, a system that produces more durable parts with higher specific strength, which can be produced in additive manufacturing machines, is obtained.

The topology optimization system realized to achieve the object of the present invention, which is defined in claim 1 and the other claims dependent thereon, comprises at least one part produced by additive manufacturing; a table on which a part is produced; at least one digital model that allows creation of a model for three-dimensional part analysis and/or design in a virtual environment; a plurality of unit design cells that allow the digital model to be created; a processor unit that allows creation of a digital model from the unit design cells; a plurality of specimens with anisotropic properties, each produced at different angles on the table; and a database which stores the mechanical properties of specimens obtained as a result of mechanical testing.

The topology optimization system according to the invention comprises a processor unit which assigns the test data obtained from the specimens based on the angle value of the unit design cells with the table.

In an embodiment of the invention, the topology optimization system comprises a processor unit which allows determination of the optimum production orientation of the part as a result of the optimization performed by taking as reference the test data indicating different angle values between specimens and the table, and by assigning the mechanical properties to the unit design cells based on the angle value with the table.

In an embodiment of the invention, the topology optimization system comprises a processor unit which allows determination of the optimum production angle of the part to be produced with respect to the table as a result of the optimization performed by taking as reference the test data indicating different angle values between specimens and the table, by matching the obtained mechanical properties with each unit design cell, when a threshold value predetermined by the designer almost completely corresponds to the relative variation of strain energy on the unit design cells between consecutive iterations.

In an embodiment of the invention, the topology optimization system comprises a processor unit which allows determination of the safety coefficients of the unit design cells by using von Mises failure criterion to which yield strength values obtained by taking as reference the stresses calculated as a result of the analysis performed by the designer and the test data indicating different angle values between specimens and the table are input.

In an embodiment of the invention, the topology optimization system comprises parts, which are manufactured on powder-bed additive manufacturing machines.

In an embodiment of the invention, the topology optimization system comprises a processor unit which allows determination of the optimum production angle of the part to be produced with respect to the table as a result of the optimization performed by assigning the mechanical properties of the unit cell on the digital model to the unit design cell, wherein the mechanical properties are provided in the database depending on the angles made with the table, and by taking into account the intensity of the stress distribution on the unit design cells.

In an embodiment of the invention, the topology optimization system comprises a processor unit which allows determination of the optimum production angle of the part to be produced with respect to the table as a result of the optimization performed by determining the mechanical properties of the unit cell on the digital model to the unit design cell, wherein the mechanical properties are provided in the database depending on the angles made with respect to the table, and by taking into account the excess number of unit design cells classified.

In an embodiment of the invention, the topology optimization system comprises a database which stores the mechanical properties of specimens with anisotropic properties obtained as a result of a tensile and/or nanoindentation test by taking as reference the test data indicating different angle values between the specimens and the table.

In an embodiment of the invention, the topology optimization system comprises unit design cells with isotropic properties.

In an embodiment of the invention, the topology optimization system comprises a processor unit which allows optimization process to be realized by calculating the strain energies of each unit design cell.

In an embodiment of the invention, the topology optimization system comprises a table which can be rotated according to the angle value at which the part has the highest modulus of elasticity, thus allowing the part to be printed at an angle where the mechanical properties thereof are optimum.

In an embodiment of the invention, the topology optimization system comprises at least one support structure which allows the part to be printed by placing the part on the table by the manufacturer according to the angle value at which the part has the highest modulus of elasticity.

A topology optimization system realized to achieve the object of the present invention is illustrated in the attached drawings, in which:

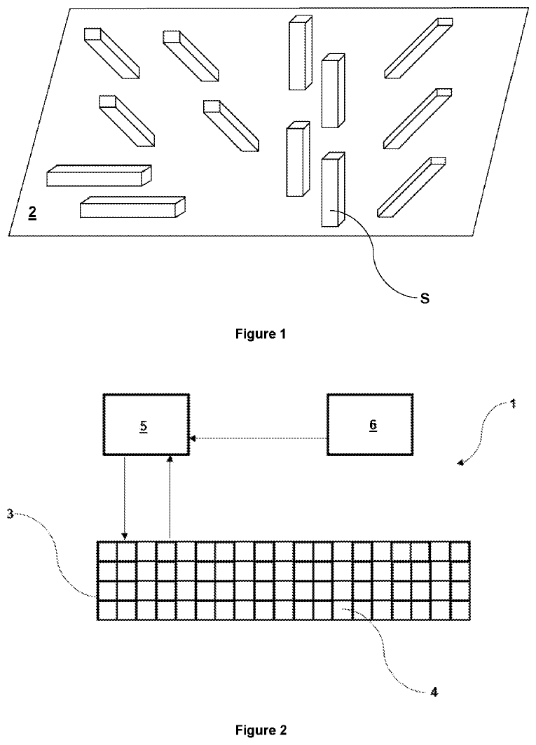

FIG. 1 is a perspective of the specimen and the table.

FIG. 2 is a schematic view of the topology optimization system.

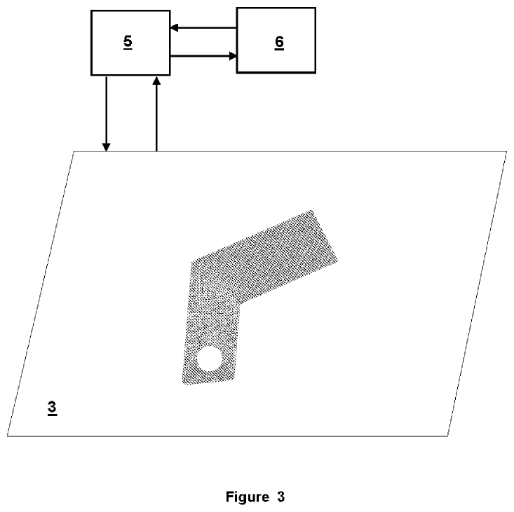

FIG. 3 is a schematic view of the digital model and unit design cells.

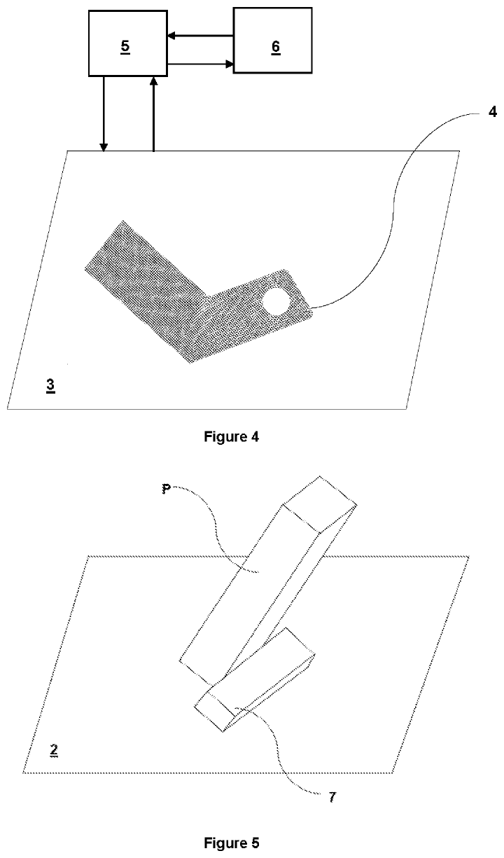

FIG. 4 is a perspective view of the table, part and support structure.

All the parts illustrated in figures are individually assigned a reference numeral and the corresponding terms of these numbers are listed below:
1. Topology Optimization System
2. Table
3. Digital Model
4. Unit Design Cell
5. Processor Unit
6. Database
7. Support Structure
(P) Part
(S) Specimen

The topology optimization system (1) comprises at least one part (P) produced by an additive manufacturing method; a table (2) which allows production of a part (P) thereon; at least one digital model (3) created for the purpose of three-dimensional part (P) analysis and/or design in a virtual environment; a plurality of unit design cells (4) that allow the digital model (3) to be created; a processor unit (5) that allows creation of a digital model (3) from the unit design cells (4); a plurality of specimens (S), each produced by the manufacturer in a different direction and/or position on the table (2); and a database (6) which is created with mechanical property data obtained from the specimens (S) (FIG. 1) (FIG. 2).

The topology optimization system (1) according to the invention comprises a processor unit (5), which enables assignment of the mechanical properties obtained from the database (6) to the unit design cell (4) individually, based on the direction and/or position of the unit design cell (4) on the digital model (3) (FIG. 3) (FIG. 4).

The parts (P) produced on the additive manufacturing machine show different mechanical properties according to the printing direction of the part (P). Specimens in coupon size (S), which are made of the same material as the part (P), are produced on the table (2) in different directions. Mechanical tests are performed on the produced specimens (S) in order to determine their mechanical properties. The data obtained as a result of the mechanical tests are stored on the database (6) by means of the processor unit (5).

The processor unit (5) ensures that the mechanical test data on the database (6) are assigned based on the directions of the unit design cells (4) provided on the digital model (3). Previously tested mechanical test data of the specimens (S) are provided in the database (6) based on the orientation of the unit design cells (4) on the digital model. By assigning the mechanical properties to the unit design cells (4) by the processor unit (5), more accurate mechanical properties and analysis and/or optimization are performed. Therefore, the result of analysis and/or optimization gives more accurate results.

In an embodiment of the invention, the topology optimization system (1) comprises a processor unit (5) which allows determination of the optimum production orientation of the part (P) on the table (2) as a result of the optimization performed by matching the mechanical properties, which are obtained with reference to the direction and/or position of the specimens (S) on the table (2), with each unit design cell (4). A virtual image of the part (P) to be produced by the additive manufacturing method is provided on the digital model (3). According to the direction and/or position of the unit design cells (4) on the digital model (3) with respect to the table (2), the data of the specimens (S) obtained by the test data beforehand and tested in that direction and/or position are assigned. In this way, each design cell (4) will be optimized with more accurate mechanical properties. As a result of the optimization, the optimum production direction and/or position of the part (P) with anisotropic property on the table (2) is determined.

In an embodiment of the invention, the topology optimization system (1) comprises a processor unit (5) which allows determination of the optimum production orientation of the part (P) on the table (2) by matching the mechanical properties, which are obtained with reference to the orientation and/or position of the specimens (S) on the table (2), with each unit design cell (4), and when a threshold value predetermined by the designer almost completely corresponds to the relative variation of strain energy on the unit design cells (4) between consecutive iterations. Thus, as a result of the strain energy reaching the determined threshold value, the optimum production orientation in which the part (P) has the optimum mechanical properties relative to the table (2) is determined.

In an embodiment of the invention, the topology optimization system (1) comprises a processor unit (5) which allows determination of the safety coefficients of the unit design cells (4) by using von Mises failure criterion to which yield strength values obtained by taking as reference the stresses calculated as a result of the analysis performed by the designer and the direction and/or position of the specimens (S) on the table (2) are input. The processor unit (5) calculates the stresses to which the unit design cells (4) on the digital model (3) are subjected, based on the loads they are exposed to. Using the von Mises failure criterion, the safety coefficients are determined by the processor unit (5) by using the yield strength values of the specimens (S) obtained with the pre-test data whose orientations of the unit design cells (4) match with respect to the table (2).

In an embodiment of the invention, the topology optimization system (1) comprises a part (P) which is produced on powder-bed additive manufacturing machines. The part (P) is produced by laying it in powder form on the table (2) and heating.

In an embodiment of the invention, the topology optimization system (1) comprises a processor unit (5) which allows determination of the optimum production orientation of the part (P) to be produced relative to the table (2) by assigning the mechanical properties of the unit cell (4) on the digital model (3), which are provided in the database (6) depending on the direction and/or position thereof relative to the table (2), to the unit design cell (4), and by considering the intensity of the stress distribution formed on the unit design cells (4). By considering the position and/or direction of the unit design cells (4) with high stress density, which have intense stresses on the digital model (3), relative to the table (2), the designer determines the optimum production orientation of the part (P).

In an embodiment of the invention, the topology optimization system (1) comprises a processor unit (5) which allows determination of the optimum production orientation of the part (P) to be produced relative to the table (2) by assigning the mechanical properties of the unit cell (4) on the digital model (3), which are provided in the database (6) depending on the direction and/or position thereof relative to the table (2), to the unit design cell (4), and by taking into account the excess number of unit design cells (4) classified. By considering the unit design cells (4) on the digital model (3), the optimum production orientation of the part (P) is determined based on the direction of the unit design cell (4) whose position and/or direction relative to the table is higher in number.

In an embodiment of the invention, the topology optimization system (1) comprises a database (6) which stores the mechanical properties of specimens (S) obtained as a result of a tensile and/or nano-sized nanoindentation test by taking as reference the direction and/or position of the specimens (S) on the table (2). Therefore, the mechanical properties of the specimens (S) produced in different directions can be determined.

In an embodiment of the invention, the topology optimization system (1) comprises unit design cells (4) with isotropic properties. Since the unit design cells (4) show isotropic properties, optimization can be performed with different failure criteria.

In an embodiment of the invention, the topology optimization system (1) comprises a processor unit (5) which allows the optimization process to be performed by calculating the strain energies of each unit design cell (4). Therefore, strain energy becomes a parameter taken into account during design phase.

In an embodiment of the invention, the topology optimization system (1) comprises a table (2) which is located in a rotatable manner in the additive manufacturing machine; and a processor unit (5) which allows the position of the table (2) to be changed in unit time periods during the production of the part (P) according to the mechanical properties obtained from the test data of the specimens (S). In this way, the part (P) is produced with a better mechanical strength.

In an embodiment of the invention, the topology optimization system (1) comprises at least one support structure (7) provided in the additive manufacturing machine, which is placed on the table (2) in unit time periods during the production of the part (P), so that the part (P) is produced with the highest modulus of elasticity (Young's Modulus) according to the mechanical properties obtained from the test data of the specimens (S). Thus, the part (P) is produced with a better mechanical strength (FIG. 5).

1-12. (canceled)

13. A topology optimization system (1) comprising:
at least one part (P) configured to be produced by an additive manufacturing method;
a table (2) which allows the part to be printed for production of the part (P) thereon;
at least one digital model (3) of the three-dimensional part (P) configured to be produced, created for the purpose of three-dimensional part (P) analysis and/or design in a virtual environment;
a plurality of unit design cells (4) that allow the digital model (3) to be created;
a processor unit (5) that is configured to allow creation of the digital model (3) from the unit design cells (4);
a plurality of specimens (S), each produced by the manufacturer in a different direction and/or position on the table (2);
at least one database (6) which is created with mechanical property data obtained as a result of a mechanical test by taking as reference the test data indicating different angle values between the specimens (S) and the table (2);
wherein the processor unit (5) is configured to enable assignment of the mechanical properties obtained from the database (6) to the unit design cell (4) individually, based on the direction and/or position and orientation of the unit design cell (4) on the digital model (3);
wherein the processor unit (5) is configured to allow determination of the optimum production orientation of the part (P) to be produced on the table (2) by matching the mechanical properties, which are obtained with reference to the orientation and/or position of the specimens (S) on the table (2), with each unit design cell (4), when a threshold value predetermined by the designer almost completely corresponds to the relative variation of strain energy on the unit design cells (4) between consecutive iterations, as a result of the strain energy reaching the determined threshold value, the optimum production orientation in which the part (P) has the optimum mechanical properties relative to the table (2) is determined; and
wherein the part (P) on the table (2) is produced on powder-bed additive manufacturing machines according to determination of the optimum production orientation of the part (P) on the table (2).

14. A topology optimization system (1) according to claim 13, wherein the processor unit (5) is configured to allow determination of the optimum production orientation of the part (P) on the table (2) as a result of the optimization performed by matching the mechanical properties, which are obtained with reference to the direction and/or position of the specimens (S) on the table (2), with each unit design cell (4).

15. A topology optimization system (1) according to claim 13, wherein the processor unit (5) is configured to allow determination of the safety coefficients of the unit design cells (4) by using von Mises failure criterion to which yield strength values obtained by taking as reference the stresses calculated as a result of the analysis performed by the designer and the direction and/or position of the specimens (S) on the table (2) are input.

16. A topology optimization system (1) according to claim 13, wherein the processor unit (5) is configured to allow determination of the optimum production orientation of the part (P) to be produced relative to the table (2) by assigning the mechanical properties of the unit cell (4) on the digital model (3), which are provided in the database (6) depending on the direction and/or position thereof relative to the table (2), to the unit design cell (4), and by considering the intensity of the stress distribution formed on the unit design cells (4).

17. A topology optimization system (1) according to claim 13, wherein the processor unit (5) is configured to allow determination of the optimum production orientation of the part (P) to be produced relative to the table (2) by assigning the mechanical properties of the unit cell (4) on the digital model (3), which are provided in the database (6) depending on the direction and/or position thereof relative to the table (2), to the unit design cell (4), and by taking into account the excess number of unit design cells (4) classified.

18. A topology optimization system (1) according to claim 13, wherein the database (6) stores the mechanical properties of specimens (S) obtained as a result of a tensile and/or nano-sized nanoindentation test by taking as reference the direction and/or position of the specimens (S) on the table (2).

19. A topology optimization system (1) according to claim 13, wherein the unit design cells (4) have isotropic properties.

20. A topology optimization system (1) according to claim 13, wherein the processor unit (5) is configured to allow the optimization process to be performed by calculating the strain energies of each unit design cell (4).

21. A topology optimization system (1) according to claim 13, wherein the table (2) is located in a rotatable manner in the additive manufacturing machine; and wherein the processor unit (5) is configured to allow the position of the table (2) to be changed in unit time periods during the production of the part (P) according to the mechanical properties obtained from the test data of the specimens (S).

22. A topology optimization system (1) according to claim 13, comprising at least one support structure (7) provided in the additive manufacturing machine, which is placed on the table (2) in unit time periods during the production of the part (P), so that the part (P) is produced with the highest modulus of elasticity (Young's Modulus) according to the mechanical properties obtained from the test data of the specimens (S).
